(19) United States
(12) Patent Application Publication
(10) Pub. No.: US 2007/0156721 A1
(43) Pub. Date: Jul. 5, 2007

(54) Efficient Webservice Data Format and Protocol Suite

(76) Inventor: Norbert Bollow, Zurich (CH)

Correspondence Address: Norbert Bollow, Weidlistrasse 18, Gruet, ZH, CH-8624, CH

(21) Appl. No.: 11/565,763

(22) Filed: Dec. 1, 2006

Related U.S. Application Data
(60) Provisional application No. 60/597,445, filed on Dec. 2, 2005.

(51) Int. Cl. G06F 7/00

(52) U.S. Cl. 707/100

(57) ABSTRACT

The efficiency of interprocess communication within a computer system, as well as the efficiency of webservice calls and responses over a network between several computers or other information processing systems, is improved by means of three innovations: A general-purpose data format which can be parsed much more efficiently than XML by computer programs, because each data value is preceded by an integer number that allows the parser to determine how much memory needs to be allocated to store the data value. A general-purpose data transport protocol achieves performance improvements through allowing multiple webservice requests and responses to be transmitted over a single connection. On top of that, a general-purpose webservice protocol provides additional flexibility not available in traditional webservice protocols, because it supports redirection of webservice responses, signals, exceptions and asynchronous as well as synchronous execution.

This is a continuation of application 60/597,445 titled “SXDF/QQP/QRPC Webservice Protocol Suite”.

### A. FIELD OF THE INVENTION

The present invention relates to the fields of interprocess commimication in computer operating systems as well as to the field of communication protocols for communication between two or more computers or other information processing systems.

### B. OVERVIEW OF THE INVENTION

The invention is best described by means of a set of draft specifications for a data format and protocols to implement the invention. Based on these draft specifications, it will be obvious to anyone skilled in the art how there are many ways of implementing this invention which are fundamentally similar while differing with respect to details.

In these draft specifications, SXDF is the data format of claims 1-11 while the communication method of claims 12-20 is implemented by means of a protocol stack consisting of the QQP protocol and the QRPC protocol. The data records which are used by the communication method of claims 12-20 are SXDF resources

SXDF (“Simple Extensible Data Format”) is a general-purpose data format, QQP (“Quick Queues Protoco”) is a general-purpose data transport protocol and QRPC (“Queueable Remote Procedure Calls”) is a fast and versatile general-purpose webservice protocol.

Compared to the widely-used XML-based webservice protocols, this protocol suite allows to achieve greater performance and greater flexibility, without losing any of the technical benefits provided by the XML-based webservice protocols.

These benefits are achieved through three mayor innovations:

The SXDF general-purpose data format can be parsed much more efficietly than XML by computer program because each data record is preceded by an integer number that allows the parser to determine how much memory needs to be allocated to store the data record.

The QQP general-purpose data transport protocol achieves performance improvements through allowing multiple webservice requests and responses to be transmitted over a single connection.

The QRPC general-purpose webservice protocol provides additional flexibnility not available in traditional webservice protocols, because it supports redirection of webservice responses, signals, exceptions and asynchronous as well as synchronous execution.

### C. Draft SXDF Data Format Specification

Abstract

The Simple Extensible Data Format (BXDF) defined in this document aims to combine the nice properties of XML (of providing a universal, text-based data format which allows adding additional data fields without breaking existing application programs) with a simple syntax which can be parsed efficiently by computer program. This data format is intended for over-the-wire use in webservice protocols, where there in generally no interest in being able to directly modify the representation of the data with a standard text editor.

1. Introduction

1.1. Overview

Over the past few years, the Extensible Markup Languagge (XML) [W3C.REC-xml] has become a widely used method for data markup. The Simple Extensible Data Format (SXDF) defined in this document aims to combine the nice properties of XML with a simple syntax which can be parsed efficiently by computer programs.

SXDF shares the following good properties of XML:
It is a universal data format which can be used for expressing arbitrarily complex data.
It is a text-based format, which makes it more convenient to debug protocol interactions which use the data format.
Data can be validated in an automated manner to ensure that it adheres to a specified data structure.
There in great flexibility in how the data format used by a given protocol can be extended without breaking existing implementations of the protocol.

SXDF differs from XML in that with SXDF the main design goals are simplicity, and allowing efficient parsing by computer programs.

SXDF is not a “markup language”. It is not intended for data which will be edited with a text editor.

A sequence of bytes (eight-bit octets) which satisfies the requirements of this specification in called a “SXDF resource”. Here is an example:

483:# Here is some data in SXDF format

1%
8:Booklist=3@
   5%
      5:Title=16:Hardware Hacking
      6:Author=19:Kevin Mitnick (Ed.)
      4:Year=4:2004
      4:ISBN=13:1-932-26683-6
      9:Publisher=8:Syngreus
   5%
      5:Title=12:We the Media
      6:Author=11:Dan Gillmor
      4:Year=4:2004
      4:ISBN=13:0-596-00733-7
      9:Publisher=8:O'Reilly
   5%
      5:Title=22:Matrix Decision Making
      6:Author=21:Alex Lowy & Phil Hood
      4:Year=4:2004
      4:ISBN=13:0-787-97292-4
      9:Publisher=11:Jossey-Bass

Here is the same data expressed in XML format:

```
<!-- Here is the same data expressed in XML markup -->
<Booklist>
  <Book>
    <Title>Hardware Hacking</title>
    <Author>Kevin Mitnick (Ed.)</author>
    <Year>2004</year>
    <ISBN>1-932-26683-6</ISBN>
    <Publisher>Syngress</publisher>
  </Book>
  <Book>
    <Title>We the Media</title>
    <Author>Dan Gillmor</author>
    <Year>2004</year>
    <ISBN>0-596-00733-7</ISBN>
    <Publisher>O'Reilly</publisher>
  </Book>
  <Book>
    <title>Matrix Decision Making</title>
    <author>Alex Lowy &amp; Phil Hood</author>
    <year>2004</year>
    <ISBN>0-787-97292-4</ISBN>
    <publisher>Jossey-Bass</publisher>
  </Book>
</Booklist>
```

Parsers for the SXDF format are generally less complicated and faster than paruers for the ZML format.

In addition, SXDF provides a general method for including digital signatures.

1.2. Pronunciation

The acronym “SXDF” is pronounced like “sixdaf”.

1.3. Notational Conventions

1.3.1. Requirements Notation

The key words “MUST”, “MUST NOT”, “REQUIRED”, “SHALL”, “SHALL NOT”, “SHOULD”, “SHOULD NOT”, “RECOMMENDED”, “MAY”, and “OPTIONAL” in this document are to be interpreted as described in BCP 14, RFC 2119 [KEYWORDS].

1.3.2. Syntactic Notation

This syntax specification of SXDF In section 2, and the specification of SXDF Document Structure Descriptions in section 3 uses the Augmented Backus-Naur Form (ABNF) notation specified in [IFC2234].

2. Syntax Specification

with “SXDF resource” we mean any sequence of bytes which matches the production labeled “resource”, below. With “byte” we mean an octet of bits.
resource=nonnegint “:” *comment dictionary “;”
nonnegint=1*digit
digit=% x30-39

The non-negative integer at the beginning of the resource MUST be equal to the number of bytes between the “:” which follows it and the “;” which ends the string. In this way, each SXDF resource is a “netstring” an described in [Netstrings].

The SXDF resource MAY contain comments; if it does, the comments MUST follow immediately after the initial colon.
comment=“#”*(% x00-09/% x0B-FF)% x0A

The fundamntal SXDF data container is the “dictionary”. It contains “key=valued pairs” which are called the elements of the dictionary.
dictionary=nonnegint “%” line-end *(string “m” value line-end)

The initial non-negatlve integer of a dictionary MUST be equal to the number of (string “=” value line-end) lines which the dictionary contains.

In the dictionary, the strings which precede the “=” in each (string “=” value line-end) line are known as “keys”. Any given key MUST NOT occur more than once in the same dictionary.
line-and=% x0A*“ ”

In the line-end production, there MAY be any number of space characters following the newline character. It is RECOMMENDED to use a number of space characters which is equal to the number of containing dictionary and sequence elements, as this improves readability for humans.
string=nonnegint “:”*% x00-FF %0A

The initial non-negative integer of a string MUST be equal to the-number of bytes between the “:” and the final newline character.

If the string contains textual data, it SHOULD be either in UTF-8 encoding or a sequence of 16-bit unicode characters that starts with the unicode Byte Order Mark, 0xFE 0xFF or 0xFF 0xFE, depending on endianness. (The case of UTF-8 encoding can be easily and reliably distinguished from this, because in UTF-8, all bytes have values is the range 0x00-0xFD.)
value=(string/dictionary/sequence/isequence/fsequence)
sequence=nonnegint “@”% x0A*(value line-end)
isequence=nonnegint “i”% x0A*(int line-end)
fsequence=nonnegint “i”% x0A*(float line-end)

In the sequence, isequence or fsequence production, the initial non-negative integer MUST be equal to the number of following (value line-end) lines. The isequence and fsequence productions are like a sequence with the difference that the values are restricted to integer or floating-point numeric constants.
int=“0”/([“-”]% x31-39*digit)
float=“0”/([“-”](“0”/% x31-39*digit) “.” 1*digit [“e”int])
3. Use of SXD for Storing Persistent Data

Besides its use as an over-the-wire format for webservice protocols, the SXDF data format MAY also be used as an on-disk format for storing persistent data. However, programs which use SXDF for this purpose SHOULD also support the EXDF data format [EXDF] which is designed for allowing data resources to be edited conveniently in a text editor.

4. Reserved Keywords

In the following two sections, special meanings will be defined for the keywords “_DSD”, “_DATA” and “_SIGNATURES”. These words MUST NOT be used an dictionary keys except as indicated below. The use of any other dictionary keys which consists entirely of a “_” character followed by three of more uppercase letters SHOULD be avoided. There are two reasons for this: One in that there could-be a need for future revisions and extensions of this specification to introduce additional reserved words. The second is that upon conversion of SXDF resourses to the editable EXDF data format, the reserved keywords MAY be replaced by equivalent words in the user's preferred language.

5. SXDF Data Structure Descriptions (DSD)

As mentioned in the introuction, SXDF data can be verified to adhere to a specific data structure, similar to how this is possible with XML.

A SXDF resource MAY contain a “_DSD” element, which, if present, is an assertion that the SXDF resource confirms to a particular SXDF Data Structure Description (DSD). The value of the _DSD element SHOULD be either a string which references the DSD by means of an URL, or a dictionary which contains the DSD explicitly. A DSD is a list of two string elements, the first of which is a URI and the second is the actual Data Structure Description in some precisely-specified, human-readable description language. The description language is identified by the URI in the first string.

Similar to the design criteria for programming languages, for such description languages human readability is more important then conciseness: It is a serious problem when DSDs are difficult to read for the (very human) developers of computer programs which read or write the corresponding SXDF-based data formats. When DSDs are difficult to read, this work becomes needlessly unpleasant, time-consuming and error-prone.

6. Digital Signatures

The SXDF format allows to add any number of digital signatures to an entire SXDF resource or to any dictionary values in the resource.

Signing an entire SXDF resource is done by creating a new resource with two-elements named “_DATA” and “_SIGNATURES”. The _DATA element contains the contents of the original SXDF resource and the _SIGNATURES element a list of digital signatures (see below).

Signing individual element values is done by replacing the value with a dictionary that has precisely two elements with the keys “_DATA” and “_SIGNATURES”.

The set of DSDs to which the resource conforms is unchanged by this operation, because from the perspective of data semantics and from the perspective of DSDs the _SIGNATURES element is ignored and the value of the _DATA element is treated as if it were in the place of this two-element dictionary. DSDs will never reference any elements named “_DATA” or “_SIGNATURES”.

The _SIGNATURES element contains a list of one or more strings, with each of the strings containing a digital signature in OpenPGP format, as specified in [RFC 2440], of the value of the DATA element, excluding the initial “m4:DATA=” but including the final “\n”.

These signatures are binary data for which the SXDF format has no need of special encoding or “ASCII armoring”.

Except if the _DATA element contains a string value, the signature MUST be of type 0x00 (“signature of a binary document”, see section 5.2.1 of [RFC2440]). and before signing, the contents of the _DATA element MUST be canonicalized by removing any and all space characters which follow a newline character but which are not part of a string value. If the _DATA element contains a string value, other signature types are also possible.

Here in an example of the canonicalization process: Suppose that within a SXDF resource, a dictionary contains the following _DATA dictionary:

5:_DATA=3%
6:Action=28:qrpc://example.com/add_books
10:ResourceID=28:34DH734HF64HF734@example.org
8:Booklist=3@
   5%
      5:Title=16:Hardware Hacking
      6:Author=19:Kevin Mitnick (Ed.)
      4:Year=4:2004
      4:ISBN=13:1-932-26683-6
      9:Publisher=8:Syngreus
   5%
      5:Title=12:We the Media
      6:Author=11:Dan Gillmor
      4:Year=4:2004
      4:ISBN=13:0-596-00733-7
      9:Publisher=8:O'Reilly
   5%
      5:Title=22:Matrix Decision Making
      6:Author=21:Alex Lowy & Phil Hood
      4:Year=4:2004
      4:ISBN=13:0-787-97292-4
      9:Publisher=11:Jossey-Bass

Then this is the canonicalized version which will be signed:

3%

6:Action=28:qrpc://example.com/add_books

10:ResourceID=28:34DH734HF64HF734@example.org

8:Booklist=3@

5%

5:Title=16:Hardware Hacking

6:Author=19:Kevin Mitnick (Ed.)

4:Year=4:2004

4:ISBN=13:1-932-26683-6

9:Publisher=8:Syngreus

5%

5:Title=12:We the Media

6:Author=11:Dan Gillmor

4:Year=4:2004

4:ISBN=13:0-596-00733-7

9:Publisher=8:O'Reilly

5%

5:Title=22:Matrix Decision Making

6:Author=21:Alex Lowy & Phil Hood

4:Year=4:2004

4:ISBN=13:0-787-97292-4

9:Publisher=11:Jossey-Bass

6. Seaurity Considerations

Webservices typically act on untrusted data; SXDF implementations therefore need to be carefully designed and revieved to prevent security breaches caused by improper handling of malformed SXDF resources.

The universal data format described in this specification incorporates a mechanism through which digital signatures can be provided for subsets of the data. The security which may be added through this mechanism depends on the strength of the corresponding mechanisms for generating and verifying the signatures and for establishing trust for the public keys which correspond to the digital signatures.

7. IANA Considerations

This document has no actions for IANA.

### REFERENCES

### Normative References

[KEYWORDS] Bradner, S., “Key words for use in RFCs to Indicate Requirement Levels”, BCP 14, RFC 2119.
[RFC2234] Crocker, D., Ed., “Augmented BNF for Syntax Specifications: ABNF”, RFC 2234.
[RFC2440] Callas, J., Donnerhacke, L., Finney, H., Thayer, R. “OpenPGP Message Format”, RFC 2440

### Informative References

[Netstrings] Bernstein, D. J., “Netutring” <http://cr.yp.to/proto/netstrings.txt>
[EXDF] Bollow, N., “EXDF—Editable Extensible Data Format”, work in progress.
[QQP] Bollow, N., “QQP—Quick Queues Protocol”, work in progress. <http://QQP.org/>
[QRPC] Bollow, N., “QRPC—Queueable Remote Procedure Calls”, work in progress. <http://QRPC.org/>
[W3C.REC-xml] Bray, T., Paoli, J., Sperberg-McQueen, C. and E. Maler, “Extensible Markup Language (XML) 1.0 (2nd ed)”, W3C REC-xml, October 2000, <http://www.w3.org/TR/REC-xml>.

### D. Draft QQP Protocol Specification

Abstract

The QQP protocol specifies a method for using a single reliable, stream-oriented connection (i.e. a TCP connection which may optionally be encrypted by means of SSL or TLS) for transmitting multiple webservice requests and responses. QQP plays the role of transport protocol for the QRPC webservice protocol, similar to how XML-RPC and SOAP often use HTTP as transport protocol.

1. Introduction

Over the past few years, “webservices” protocols such as for example SOAP or XML-RPC have started becoming popular. The fundamental idea of “webservices” is to access functionality on another computer by means of standardised multi-purpose protocols and a standardized extensible data format. For example, when using the “webservices” paradigm to specify a message transport system, you don't specify the protocol and data format from scratch like it is done for SMTP in [RFC2821] and [RFC2822]; instead you specify them in terms of a general-purpose data format (often XML) and a general-purpose protocol for transporting data between computers.

QQP, the Quick Queues Protocol, is such a general data transport protocol, specifically for data in the SXDF format [SXDF]. As far as QQP is concerned, there is no dif ference between webservice requests and responses; QQP merely provides something that could be called a “full-duplex webservlce data communication channel” between two Hosts, which both parties can use to transait any number of webservice requests and responses.

The data which in transmitted over QQP connections consists of “QQP resources” which are SXDF resources consisting of an element named Envelope (which contains QQP-related and routing information) and an element named Data (which can contain arbitrary payload). In particular, the Envelope contains an Element named Action which specifies what the receiver should do with the resource.

The fundamental idea of QQP is that a single TCP [RFC793] connection can be used for all webservice requests and responses between a given pair of Hosts as long as the amount of data in each request or response is small.

This is advantageous because of the various overheads incurred by creating a new connection, which include
The tree-way handshake for establishing a TCP connection; the time required for this is bounded from below by the network's Round-Trip Time.
The initially slow speed of TCP connections, which is necessary to dynamically maximize throughput without risking to overload the network.
For encrypted connections, the overhead of authentication and session key negotiation.

On the other hand, for requests and responses which contain large amounts of data it is better to create a separate TCP connection so that the transfer of large QQP resources does not prevent the the concurrent transfer of other data via QQP.

Alternatively to TCP connections, any other implementation of reliable data streams can be used.

2. Establishing the Communication Channel

2.1. Opening Connections

For an unencrypted QQP communicatlon channel based on TCP, one of the parties opens a TCP connection which uses port 26 on both ends of the connection. As soon as the connection is established, both parties send a QQP resource called the “Greeting” which contains values for “QQPstreamID”, “mLimit”, “cLimit”, “eLimit”, “Capabilitiem” and “ExceptionsTo” (see below). This TCP connection is called the “Main QQP Connection”. Each Host can start sending data over the main QQP Connection as soon as it has received the Greeting of the other Host. In addition, after the Greeting has been received (either immediately at that time or at any later time as long as no Farewell has been sent or received) each Host may open one or more additional TCP connections to port 26 at the remote Host (with the originating port different from 26). Each such connections in called an “Extra QQP Connection”. Extra QQP Connections are used only for data transfer in one direction, from the Host which initiated the connection to the Host where port 26 is used. (Allowing bidirectional data transfer over Extra QQP Connections could create a security problem.)

For an encrypted QQP communication channel via the TLS Protocol [RPC2246] the process of establishing the communication channel is identical except that port 27 instead of port 26 in used.

Similarly QQP communication channels can be established over any other protocol layer which allows to establish multiple reliable data streams between two Hosts.

2.2. The Greeting in the Main QQP Connection

The Greeting is a QQP resource which contains values for “QQPstreamID”, “mLimit”, “eLimit”, “cNum”, “Capabilities” and “ExceptionsTo”.

The QQPstreamID element holds a string value which MUST be unique among all QQP connections originating from the same host. For example, a Universal Unique Identifier (see [UUID]) MAY be used.

The values for “mLimit”, “eLimit” and “cNum” MUST be positive integer values, while the value for “Capabilities” MUST be a list of strings and the value for “ExceptionsTo” MUST be a qrpc: URL [QRPC].

The value for “mLimit” specifies a size limit for data items (which are QQP resources) that the Host which generated the Greeting will accept via the Main QQP Connection. The value for “eLimit” is the corresponding size limit for data items which will be accepted via Extra QQP Connections. The “eLimit” value SHOULD be significantly greater than the “mLimit” value.

The size of a QQP resource is the value of the datasize field plus the number of digits of the datasize field plus two.

ExceptionsTo SHOULD be a qrpc: URL where QRPC Exception resources can be received. If Sender detects wrong behavior of the QQP server, it SHOULD make an attempt to use this qrpc URL for reporting the error.

If one Host attempts to send a QQP resource which is larger than the relevant limit which has been specified by the receiving Host, the receiving Host SHOULD send a Farewell and then the connection over which the oversized QQP resource is being sent. In addition, the receiving Host SHOULD send a QRPC Exception resource to the ExceptionsTo URL which was specified by the sender of the oversized resource in its Greeting.

The value for “cNum” is an estimate on the number of concurrent Extra QQP Connections which the Host that generated the Greeting will be likely to accept from the same sender. This does not imply a promise to accept that many connections. Each Host may refuse Extra QQP Connections at its sole discretion. However, at least most of the time, at least one Extra QQP Connection SHOULD be accepted from any host from which QQP connections are accepted at all.

Capabilities is an array of strings. For example, if Receiver in capable of processing resources where the Action element contains a grpc: URL [QRPC], the Capabilities element should contain the string “qrpc”. Further common capability strings are “tcp:26” and “tls:27” which indicate how Extra QQP Connections can be created.

A request will be made to IANA to operate a registry for the possible string values in the Capabilities list in the Greeting, and their meaning.

2.3. The Greeting in Extra QQP Connections

In Extra QQP Connections the Greeting does not provide values for “mLimit”, “eLimit”, “cNum”, “Capabilities” or “ExceptionsTo”; the values from the Greeting of the Main QQP Connection apply. However a unique QQPstreamID value MUST be provided, and depending on circumstances Resumes and Position elements may also be required:

If the purpose of the Extra QQP Connection in to resume transmission of data from a previous QQP connection which died for some reason (possibly due to network problems or due to a software crash at either end of the connection) the value of the Resumes element MUST be the QQPstreamID of the QQP data stream which is being continued, and Position indicates the position (in the sense of counting bytes, with the first byte in the data stream having number 1) from which transmission will start. In this case the data following this Greeting may not start with a valid QQP resource when viewed on its own; however together with the previously-transmitted bytes of the stream which is being resumed, the data stream MUST be a sequence of valid QQP resources.

Otherwise (if the Greeting of the Extra QQP Connection does not have the Resumes and Position elements) the Greeting is followed by one or more complete QQP resources.

2.4. QQP_FORK Resources

For each Extra QQP Ccnection, the sender MUST send, over the Main QQP Connection, a “QQP_FORK resource” which is a QQP resource with the string “QQP_FORK” (without the quotes) as the value of the Action field and the QQPstreamID of Extra QQP Connection as the value of the Data element.

The QQP_FORK resource MAY be sent before the Extra QQP Connection is opened or it MAY be sent afterwards. However it MUST be sent before a QQP_EOT (see below) is sent. The purpose of the requirement to send a QQP_FORK resource for each Extra QQP Connection is that this avoids the possibility of a race condition which could result in data loss if an Extra QQP Connection is-opened at roughly the same time as the other party attempts to close the communication channel.

3. Data Transport

3.1. Overview

The purposes of the QQP protocol is to transport data, which is required to consist of QQP format data resources, between two Hosts. The data can be transferred over the Main QQP Connection (which allows data to be transferred in both directions) and over Extra QQP Connetions (each of which allows data transfer in one direction only, with a greater size limit on the QQP resources that can be transmitted).

Each QQP resource which is transmitted via QQP consists of two elements named Envelope and Contents:

An element named Envelope MUST be present, it SHOULD contain at least an Action element and an Exceptionsto element. It MAY also contain a ResponseTo element.

An element named Contents SHOULD also be present, it MAY contain arbitrary QQP data. For example the Contents element MAY contain human-readable data in QQP format, or its value MAY be merely a string of length zero, or its value MAY be a string containing encrypted data.

A digital signature as described in section 6 of [SXDF] MAY be present, In this case the _DATA element which holds the signed data SHOULD contain both the Envelope and the Contents elements.

3.2. Envelope Elements

3.2.1. Action Element

Sender SHOULD ensure that each QQP resource which it transmits contains an Action element with a value which is a valid URL of a type which receiver has included in the Capabilities array in the Greeting.

3.2.2. ExceptionsTo Element

The ExceptionsTo element specifies an qrpc: URL to which QRPC Exception resources related to the present QQP resource should be sent.

3.2.3. Responseto Element

If present, the optional ResponseTo Element specifies the URL to which the specified Action will cause a response to be sent. If it is known that currently no data can be sent to this URL, the receiver of the resource MAY sand a QRPC Exception resource to the ExceptionsTo URL instead of executing the requested Action.

3.3. QQP_ACK Resources

As data is received over a QQP connection, the receiving host SHOULD periodically send a QQP_ACK resource to acknowledge that all the data up to a certain point in the data stream has been successfully received and safely stored or otherwise processed so that it can be deleted at the sending host without risk of data loss. In addition

For these resources, the value of the Action element is the string “QQP_ACK” (without the quotes), while the Data element contains two elements, QQPstreamID and Position. QQPstreamID has a string value which identifies the QQP connection to which the acknowledgment refers, and Position has a positive Integer value which indicates a position (in the sense of counting bytes, with the first byte in the data stream having number 1) up to which (inclusive) all the data in the stream has been processed so that it can be safely deleted on the sending host.

In the case that the data stream (to which the QQP_ACK resource refers) in a continuation of a data stream from a previous QQP connection which died, the Position counter refers to the number of bytes since the beginning of the original data stream.

4. Closure and Death of Connections

4.1. Closing QQP Extra Connections

QQP Extra Connections can be closed by simply closing the TCP connection after the transmission of a QQP resource has been completed. The receiving host SHOULD use the main QQP connection to send a QQP_ACK when the data has been safely stored or processed.

4.2. Orderly Closure of the QQP Main Connection

When one party of the connection wants to close the QQP Main Connection for any reason, it SHOULD send over this connection a QQP_EOT resource which is a resource where the value of the Action element is the string “QQP_EOT” (without the quotes) and the Data element contains two elements, Position ad Comment. The value of the Position element is the positive integer which corresponds to the position of the first byte of the QQP_EOT resource. This information is actually redundant because the receiving host SHOULD be keeping track of the position in the data stream anyway so that it can send QQP_ACKs as described in section 3.3. above. The reason for sending this in the QQP_EOT resource is to make it easier to debug situation where QQP connections fail to close properly. If this debugging information disagrees with the value that the receiving host has computed, an Exception MAY be generated, but the Position information in the QQP_EOT resource SHOULD otherwise be ignored.

With the exception of QQP_FORK and QQP_ACK resources, both hosts SHOULD NOT start the tranmission of further QQP resources after one of the hosts has sent a QQP_EOT resource; however where transmission of QQP resources has been started already, these transmissions SHOULD be completed provided that this is within the power of the computer program which implements QQP.

When one host has sent a QQP_EOT resource, the other host SHOULD also do this as soon as it is able to do so over the QQP Main Connection, i.e. the QQP_EOT resource SHOULD be sent immediately after the current QQP resource transmission (if any) over the QQP Main Connection is complete, and after any pending QQP_FORK resources have been sent.

After the QQP_EOT resource has been sent, the QQP Main Connection MUST NOT be used for sending any data except QQP_ACK resources, and each QQP Extra Connection MUST be closed by the sending host as soon as the current SXDF resource transmission is complete.

Each host will then use the QQP Main Connection only to send QQP_ACKs until all pending data has been so acknowledged. When that has happened, both hosts have the informtion to know that this is the case. Then each host SHOULD close the connection.

4.3. Connection Death and Re-Sending of Data

QQP implementations MUST be prepared to handle the possibility that for whatever reasons sometimes QQP connections will die without having been closed in an orderly manner as indicated above. In such situations, each host SHOULD, for each QQP data stream on which it has been sending data for which no QQP_ACK has arrived, at the next opportunity establish a QQP Extra Connection and resume sending the data, starting from right after the Position of the latest QQP_ACK.

5. Security Considerations

Webservices typically act on untrusted data; they therefore need to be carefully designed and reviewed to prevent security breaches. When webservice requests are transmitted over an untrusted network, firewalls are RECOMMENDED as an additional line of defense.

It is RECOMMENDED that each resource which is the sent should be digitally signed. The received MAY reject resources which do not have a valid signature from an authorized sender of webservies data.

When potentially privacy-sensitive data is transmitted over untrusted network, the use of encrypted connections (as provided e.g. by TLS) is RECOMMENDED.

6. IANA Considerations

A request will be made to IANA to operate a registry for the possible string values in the Capabilities list in the Greeting, and their meaning.

### REFERENCES

### Normative References

[RFC793] Postel, J. (Ed.): Transmission Control Protocol, RFC 793, September 1981.
[RFC1738] Berners-Lee, T., Masinter, L., McCahill, M., Eds., “Uniform Resource Locators”, RFC 1738.
[SXDF] Bollow, N., “SXDF—Simple Extensible Data Format”, work in progress. <http://SXDF.org/>
[QRPC] Bollow, N., “QRPC—Queueable Remote Procedure Calls”, work in progress. <http://QRPC.org/>
[KEYWORDS] Bradner, S., “Key words for use in RFCs to indicate Requirement Levels”, BCP 14, RFC 2119, March 1997.
[RFC2440] Callas. J., Donnerhacke, L., Finney, H., Thayer. R. “OpenPGP Message Format”, RFC 2440

### Informative References

[UUID] International Organization for Standardization: “Information technology—Open systems Interconnection—Remote Procedure Call (RPC)”, ISO/IEC 11578:1996.
[RFC2821] Klensin, J., Ed., “Simple Mail Transfer Protocol”, RFC 2821.
[RFC2822] Resnick, P., Ed., “Internet message format”, RFC 2822.

### E. Draft QRPC Protocol Specification

Abstract

The QRPC (Queueable Remote Procedure Calls) protocol is a fast and versatile general-purpose webservice protocol. QRPC can be used as a faster replacement for XML-RPC or SOAP, or it can be used for more general kinds of webservices which integrate technical and business processes across trusted or untrusted networks. QRPC brings the flexibility of the UNIX inter-process communication mechanism with pipes, signals and redirection of “standard input”, “standard output” and “standard error” to the realm of webservices.

1. Introduction

1.1. Overview

Over the past few years, “webservices” protocols such as for example SOAP or XML-RPC have started becoming popular. The fundamental idea of “webservices” is to access functionality on another computer by means of standardized multi-purpose protocols and a standardized extensible data format. For example, when using the “webservices” paradigm to specify a message transport system, you don't specify the protocol and data format from scratch like it is done for SMTP in [RFC2821] and [RFC2822]; instead you specify them in terms of a general-purpose data format (often XML) and a general-purpose protocol for transporting data between computers.

QRPC is a general-purpose Remote Procedure Call webservice protocol, which is based on the SXDF data format [SXDF] and which uses the QQP protocol [QQP] for data transport.

QRPC is fundamentally more flexible than other webservice protocols, as discussed in [DESIGN].

1.2. Examples of Possible Uses of QRPC

1.2.1. Simple RPC Request and Response

The fundamental idea of a Remote Procedure Call is to send some data (the parameters) to an URL at a remote computer, where a program will run, which acts on the data and sends a response back.

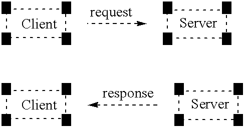

This can be achieved with QRPC just like this is possible also with XML-RPC or SOAP. For this kind of application, the main difference is that QRPC uses a data representation which is more compact and which can be parsed more efficiently.

1.2.2. Certifying that a Given HTTP POST isn't Spam

As explained in [ANTISPAM], a useful anti-spam measure for messages which are submitted via HTTP POST is to ask the web browser which POSTs the message to request a confirmation (from a server which is operated by the user's ISP) that this user isn't making unreasonably many such HTTP POST requests.

With QRPC this can be implemented as follows:

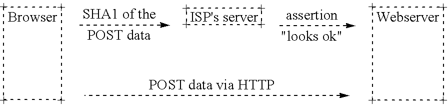

The main point here is that the Browser can send the SHA1 of the POST data to the ISP's server and then it can proceed immediately to send the POST data to the webserver via HTTP. The browser does not wait for a response from the ISP'e server because QRPC allows to redirect the result of the “create an assertion that this looks ok” webservice request directly to the Webserver.

1.2.3. Requesting a Data Stream

Someone who wishes to listen to streamed audio or video content from a website can send an QRPC request which initiates the transmission of streamed data. QRPC is flexible enough that the streamed data can be sent directly as the response to the webservice request; it is not necessary to set up a separate data connection. QRPC Signals can be used to request a change of bandwidth use, or to stop the transmission altogether.

1.2.4. Secure Webservice Interaction Across Firewalls

In QRPC, a client and a server can exchange data over an untrusted network, like this:

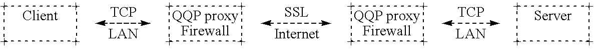

Each of the arrows in this picture represents a TCP or SSL connection over which SXDF resources are transmitted. On each of the firewall machines, a QQP proxy server receives and forwards the SXDF resources. The proxy server can also act as a filter which discards unauthorised QRPC requests.

1.3 Editorial and Conformance Conventions

The key words “MUST”, “MUST NOT”, “REQUIRED”, “SHALL”, “SHALL NOT”, “SHOULD”, “SHOULD NOT”, “RECOMMENDED”, “MAY”, and “OPTIONAL” in this specification are to be interpreted as described In RFC2119 [KEYWORDS].

Consequently, we use these capitalized key words to unambiguously specify requirements over protocol and application features and behavior that affect the interoperability and security of implementations. These key words are not used (capitalized) to describe the structure of SXDF resources, and this structure is specified unambiguously by means of SXDF Data Structure Descriptions [SXDF, section 4] and we wish to reserve the prominence of these terms for the natural language descriptions of protocols and features. For instance, an SXDF element might be described as being “optional”.

1.4 Acknowledgments

Discussions with, and comments from the following people are gratefully acknowledged:
Nicolai Guba
Chris Smith
James Michael DuPont
2. QRPC Messages.

Section 2.1 provides an overview of how the SXDF resources, which are used in th QRPC protocol, are structured. The semantics are explained in section 3.

2.1 Overview

The SXDF resources used in the QRPC protocol all have the following basic structure:

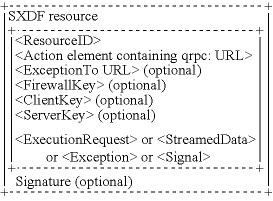

Remark: While the Signature is optional as far as this protocol specification in concereed, implementations MAY discard every SXDF resource which does not have a valid Signature. Such filtering MAY also be done by a QQP proxy.

The Executionrequest or StreamedData or Exception or Signal element has the following structure:

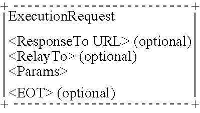

Remark: The <EOT> is required unless the client will send further data in the form of StreamadData. The Params element can contain any SXDF data.

The optional RelayTo element may contain a qrpc: URL or a list of such URLs.

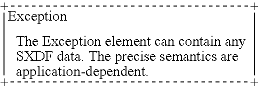

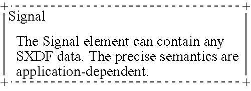

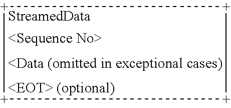

Remark: The EOT is required in the final StreamedData package from the client to the server (the only exception to this rule is if there was an EOT in the ExecutionRequest, which means that the client does not send any StreamedData packages to the server).

3. Processing Streams Of Data

Unlike SOAP and XML-RPC the QRPC protocol specified here is also designed to support stateful webservices. The client creates a webservice session by means of an ExecutionRequest. The ExecutionRequest will generally contain some parameters, and subsequent messages will transmit further data. (In such follow-on messages that are intended for the same webservice session, the StreamedData element is used instead of the ExecutionRequest element.) The final data packet from the client contains an EOT (“end of transmisson”) element which effectively closes the channel.

If the client is sending a stream of data (i.e. the ExecutionRequest does not already contain an EOT element), the subsequent data packages have sequence numbers, and generally for each data package, the server will send a response packet (containing a StreamedData element with the same sequence number) back to the client. The only exception to this rule is if due to an error, the server has generated an Exception (see below) and included an EOT element in a response. (If the server includes an EOT element in a response without the client having sent an EOT element first, it MUST generate an Exception.) In this case, the server MUST ignore all subsequent data packages with the same session ID.

The client MUST wait until before sending the next data packet until a response packet has been received to the ExecutionRequest. Afterwards the client MAY send multiple data packages without waiting for response packets. However the client MUST stop sending data immediately if it receives a response which contains an EOT element. (Waiting for each response is necessary if the next packet cannot be computed until the response to the previous packet has been received, but it many situations it would just needlessly slow data tranmission.) The behavior of QRPC servers in the case that the server receives a data package with a sequence number which is higher than the expected next sequence number SHOULD be configurable on a per-service basis, since some services may be able to tolerate occasional los of data packages while other services need complete data in order to be able to obtain correct results. In the case that the server in configured to wait for packages with lower sequence numbers but expected packages are not arriving within a reasonable timeframe, the server MAY generate an exception which contains a request for re-sending of lost data packages. If waiting for re-sendng of lost data packages is not possible (e.g. due to time constraints, or because the necessary resources for buffering packages are not available, or because a configured maximal waiting time has expired) the server MUST generate an Exception and in addition send a StreamedData data package with the SequenceNo set to the expected next sequence, and which in addition contains an EOT element but no <Data> element.

If the client is sending only a single data package (i.e. the ExecutionRequest already contains an EOT element), the server can either respond with a single data package (with sequence number 0 and an EOT element), or it can respond with a stream of data.

3.1. Generation of Session Identifiers.

For each QRPC session, there can be up to three different session identifiers.

Messages which are sent across untrusted networks SHOULD contain a FirewallKey element. The FirewallKey in generated by the Client before sending the initial ExecutionRequest . This key MUST consist of at least 16 characters in the base64 alphabet, and it SHOULD contain at least 92 bits of entropy. It SHOULD be generated by the QRPC implementation using a cryptographically strong source of random data. The QRPC implementation MAY allow the user to request a FirewallKey size which is different from the default provided that a FirewallKey of the requested size contains at least 92 bits of entropy. The Client MAY use a method for FirewallKey generation which doew not guarantee the random bits to be completely independent of each other, but then the size of the key SHOULD be increased to ensure that the minimum of 92 bits of entropy in achieved. Both the Client and the Server MUST include thin FirewallKey in each subsequent SXDF resource which is part of the same session.

The Client MAY in addition generate a ClientKey and include it in the ExecutionRequest. ln this case the server MUST include this ClientKey in every SXDF resource which it generates as part of the same session. The Client is completely free in the choice of this ClientKey. For example, the client MAY use a pre-existing database key for this purpose.

If the Server's response to the ExecutionRequest does not already contain an EOT element, the Server MUST generate a ServerKey and include it in the response to the ExecutionRequest. The Client MUST include this ServerKey in every further SXDF resource which is part of the same session. The server SHOULD use a method for ServerKey generation which prevents multiple sessions from using the same ServerKey. For example, the server MAY use a Universal Unique IDentifier (see [UUID]) as ServerKey.

3.2. Exceptions

The servor reacts to errors by generating an Exception. Depending on the ser verity of the error, the webservice process may possibly need to be terminated, in which case in addition to the Exception a response data package which contains an EOT element MUST be generated.

3.3. Redirection

The ExecutionRequest may optionally contain a qrpc: URL to which response packages should be addressed, and it may optionally contain a URL to which Exception packages should be addressed. By default both types of packages are directed to the Sender URL of the original ExecutionRequest.

3.4. Signals

Signals are data packages sent from the client to the server which do not contain a sequence number, and which may be sent at any time, i.e. even after the final data package (which contains the EOT element). For example, the server may implement a type of signal which causes it to immediately generates an exception, send a final response data package (containing an EOT element), and discard any remaining data from the client which may still be unprocessed.

3.5. Handling Exceptions.

Server and webservice implementations SHOULD have detailed documentation of all exceptions that they can generate.

Generally the client forwards all Exception packets which it cannot handle to a general exception handler application that will inform the system operator in an appropriate manner.

If the client is not capable of handling any exceptions, redirection of Exceptions to the general exception handler application can be used.

4. Security Considerations

Webservices typically act on untrusted data; they therefore need to be carefully designed and reviewed to prevent security breaches. When webservice requests are transmitted over an untrusted network, firewalls are RECOMMENDED as an additional line of defense.

5. IANA Considerations

A request will be made to IANA to add “qrpc:” to the registry of URL schemes.

### REFERENCES

### Normative References

[RFC1738] Berners-Lee, T., Masinter, L., McCahill, M., Eds., “Uniform Resource Locators”, RFC 1738.
[SXDF] Bollow, N., “SXDF—Simple Extensible Data Format”, work in progress. <http://SXDF.org/>
[QQP] Bollow, N., “QQP—Quick Queues Protocol”, work in progress. <http://QQP.org/>
[KEYWORDS] Bradner, S., “Key words for use in RFCs to Indicate Requirement Levels”, BCP 14, RFC 2119, March 1997.

### Informative References

[ANTISPAM] Bollow, N., “Spank spammers, but beware the trolls”, work In progress.
[DESIGN] Bollow, N., “Webservice protocol design for economic liberty and observability”, work in progress. <http://bollow.ch/wsprot.pdf>
[UUID] International Organization for Standardization: “Information technology—Open systems Interconnection—Remote Procedure Call (RPC)”, ISO/IEC 11578:1996.
   End of the Specification.

I claim:

1. A data format for structured data, wherein the data is organized as keyword-value pairs where the values can be of different types, and where each data value is preceded by an integer number which provides information on the number of characters or items in the following data so that software for parsing the data format can generate a tree representation of the data in a single pass through the formatted data, always first allocating the appropriate amount of memory when this integer number has been parsed, and then filling this allocated memory as the parser continues reading after this integer number.

2. The data format of claim 1, wherein the integer numbers numbers are stored in decimal representation as ASCII characters.

3. The data format of claim 1, wherein the possible data types for data values comprise string values as well as “dictionaries” that consist of an arbitrary number of keyword-value pairs.

4. The data format of claim 3, wherein the allowed values in the “dictionary” data type can themselves be of several data types including string values and “dictionary” values, so that arbitrarily complex trees of data can be represented in the data format.

5. The data format of claim 3, wherein string values are either in UTF-8 encoding or a sequence of 16-bit Unicode characters that starts with the Unicode Byte Order Mark, 0XFE 0XFF or 0XFF 0XFE, depending on endianness.

6. The data format of claim 3, wherein the possible data types for data values include a list type.

7. The data format of claim 1, wherein not only the data values but also each keyword is preceded by an integer number indicating the length of the keyword string.

8. The data format of claim 1, wherein each entire data record is preceded by an integer number indicating the size in bytes of the entire data record.

9. The data format of claim 6, wherein a comment may be present after the initial integer number that indicates the size of the entire data record.

10. The data format of claim 1, wherein each entire data record may contain an URL which references a data structure specification, so that the data record is invalid if its structure does not conform to the referenced specification.

11. The data format of claim 1, wherein a standard method is dcfimed for including a digital signature of some or all of the included data.

12. A method of communication between two electronic data-processing systems wherein a “communication channel” is established between the two dataprocesing systems and then a series of data records is transmitted over this communication channel, so that these data records can have varying functions in the communication process including data records indicating a service request and records indicating a response to a previous request, and so that the function of each data record is indicated by each data record itself and it is possible to use one “communication channel” for a wide variety of data records with different functions.

13. The method of claim 12, wherein one of the possible functions of data records is an additional communication directed to the software system which handles a previous request.

14. The method of claim 12, wherein one of the possible functions of data records is to indicate an “exception” or error condition concerning a previous request.

15. The method of claim 12, wherein an URL is used in each data record to indicate what software service the data record is addressed to.

16. The method-of claim 15, wherein data records which indicate requests may contain an URL to which responses to the request should be addressed.

17. The method of claim 15, wherein data records which indicate requests may contain an URL to which data records that indicate an “exception” or error condition concerning should be addressed.

18. The method of claim 12, wherein a unique identifier is generated for each request, and this identifier is then referenced in any further data transmissions from the requestor to the system which handles the request, and in any responses.

19. The method of claim 12, wherein an arbitrarily long time is allowed to elapse between a request and corresponding responses.

20. The method of claim 12, wherein the communication method is implemented by means of a protocol stack consisting of two protocols, with one of the protocols implementing the notion of “communication channel” and the transmission of data records over an underlying communication network, and the other protocol defining the semantics of data records as having one of several functions including the function of a service request or the function of a response to a previous request.
